(19) United States
(12) Patent Application Publication
(10) Pub. No.: US 2017/0357399 A1
(43) Pub. Date: Dec. 14, 2017

(54) BENDED DISPLAY DEVICE OF CONTROLLING SCROLL SPEED OF EVENT INFORMATION DISPLAYED ON SUB-REGION ACCORDING TO POSTURE THEREOF, AND CONTROL METHOD THEREFOR

(71) Applicant: LG ELECTRONICS INC., Seoul (KR)

(72) Inventors: Doyoung LEE, Seoul (KR); Juhwan LEE, Seoul (KR); Sihwa PARK, Seoul (KR)

(73) Assignee: LG ELECTRONICS INC., Seoul (KR)

(21) Appl. No.: 15/539,988

(22) PCT Filed: Dec. 29, 2014
(86) PCT No.: PCT/KR2014/012960

§ 371 Date: Jun. 26, 2017

(51) Int. Cl. G06F 3/0485; G02F 1/1333; H04M 1/725; G06F 3/0488; G06F 3/0482; H04M 1/2745

(52) U.S. Cl. CPC G06F 3/0485; G06F 3/0482; H04M 1/274525; H04M 1/72583; G06F 3/0488; G02F 1/133305

(57) ABSTRACT

A bended display device according to the present specification comprises: a bended display having a main region facing the front side of the device and a sub-region with a certain curvature extending from the main region; a tilt sensor which sends the posture of the device; and a control unit which controls the functions of the device, wherein the control unit displays information on an event which is generated while an application displaying a screen on the main region is running, and can control the scroll speed of event information displayed on the sub-region in conjunction with the posture of the device which is detected by the tilt sensor.

### TECHNICAL FIELD

The present specification relates to a bended display device having a main region facing the front side of the device and a sub-region of a prescribed curvature extended from the main region and a method of controlling therefor, and more particularly, to a bended display device controlling the scroll speed of event information displayed on the sub-region according to a posture of the device and a method of controlling therefor.

### BACKGROUND ART

Various electronic devices are used in our daily life with the help of the development of a semiconductor technology and a communication technology. Among the various electronic devices, a display device capable of watching and listening multimedia is most widely used.

Recently, a foldable display to which flexibility is provided by replacing a glass plate around liquid crystal of an LCD (liquid crystal display), an LED (light emitting diode), an OLED (organic LED), and an AMOLED (active matrix OLED) with a plastic film receives attention as a display used for a device. The display is divided into a bended display capable of maintaining a bended shape in a manner of being connected to a main body of a device and a flexible display capable of being freely folded and unfolded.

When the bended display is connected to the main body of the device, the bended display may have a main region facing the front side of the device and a sub-region having a prescribed curvature in a manner of being extended from the main region. A function of the device can be displayed and managed by linking information on the main region with information on the sub-region. In particular, the sub-region of the bended display can be used as a function region and a display region. For example, various informations such as event information corresponding to an application of the main region, attachment information, status information, control information, and the like can be provided via the sub-region. If it is necessary to control a screen of the main region, it is able to control a function on the screen by controlling the sub-region.

Meanwhile, a user of the device may or may not pay attention to various informations displayed on the sub-region. In particular, when the user of the device pays attention to information displayed on the sub-region, the user may pay attention to the information displayed on the sub-region as much as the extent not affecting the use of an application displayed on the main region. Hence, it is necessary to provide the user with a method of displaying the information displayed on the sub-region in association with an action of the device user.

### DISCLOSURE OF THE INVENTION

### Technical Task

The present specification is designed by recognizing the aforementioned related art. An object of the present specification is to provide a bended display device capable of controlling the scroll speed of event information displayed on a sub-region according to a posture of the device and a method of controlling therefor.

### Technical Solution

To achieve these and other advantages and in accordance with the purpose of the present invention, as embodied and broadly described, according to one embodiment, a bended display device includes a bended display including a main region facing the front side of the device and a sub-region having a prescribed curvature in a manner of being extended from the main region, a tilt sensor capable of sensing a posture of the device, and a control unit configured to control a function of the device, the control unit configured to display information on an event (hereinafter, event information), which is generated in the middle of executing an application for displaying a screen on the main region, on the sub-region, the control unit configured to control the scroll speed of the event information displayed on the sub-region in a manner of associating the scroll speed with the posture of the device sensed via the tilt sensor.

According to one embodiment of the present specification, if the posture of the device is tilted in a manner that a direction at which the sub-region is facing is tilted to a direction at which the main region is facing, the control unit can increase the scroll speed of the event information displayed on the sub-region. In this case, the control unit can increase the scroll speed in proportion to a tilted level of the posture of the device. And, if the direction at which the main region is facing is tilted to the direction at which the sub-region is facing, the control unit can decrease the scroll speed of the event information displayed on the sub-region.

According to one embodiment of the present specification, if the posture of the device is tilted in a manner that a direction at which the sub-region is facing is tilted to a direction at which the main region is facing, the control unit can control the scroll of the event information displayed on the sub-region to be started.

According to one embodiment of the present specification, if the posture of the device is tilted in a manner that a direction at which the sub-region is facing is tilted to a direction at which the main region is facing, the control unit can control the event information displayed on the sub-region to be scrolled in a direction orthogonal to a direction in which the posture of the device is tilted.

The bended display according to the present specification can output an input signal to the control unit by sensing a contact of a user. If the user touches the sub-region while the event information displayed on the sub-region is scrolled, the control unit can stop scrolling the event information displayed on the sub-region.

According to one embodiment of the present specification, the control unit can maintain the scroll of the event information displayed on the sub-region in a paused state while the user maintains the touch touched on the sub-region.

According to a different embodiment of the present specification, if the user retouches the sub-region after the scroll of the event information displayed on the sub-region is paused, the control unit can control the scroll of the event information displayed on the sub-region to be started again.

According to a further different embodiment of the present specification, if the user sweeps the touch in a certain direction while the touch touched on the sub-region is maintained, the control can control contents of the event information displayed on the sub-region to move in the direction to which the touch is swept.

Meanwhile, if the posture of the device is returned to a posture at the time of generating the event information, the control unit can stop displaying the event information on the sub-region.

According to one embodiment of the present specification, if the application for displaying the screen on the main region corresponds to an application for playing digital media, the control unit can control a volume of the digital media to be reduced from the timing at which the posture of the device sensed by the tilt sensor is tilted.

According to one embodiment of the present specification, if the application for displaying the screen on the main region corresponds to an application for playing digital media, the control unit can control the playback of the digital media to be stopped from the timing at which the posture of the device sensed by the tilt sensor is tilted.

According to one embodiment of the present specification, if the application for displaying the screen on the main region corresponds to an application for playing digital media using real-time data received from the external, the control unit can store the data of the digital media received in real-time from the timing at which the posture of the device sensed by the tilt sensor is tilted.

In this case, if the posture of the device is returned to a posture at the time of generating the event information, the control unit can stop storing the data. And, the control unit can display information related to the stored data on the sub-region. Moreover, if the stored data include images, the control unit can display at least one of the stored images on the sub-region as a thumbnail. In this case, the thumbnail may correspond to a plurality of thumbnails arranged at the sub-region according to the passage of time. The bended display can output an input signal to the control unit by sensing a contact of a user. Hence, if the user touches one of a plurality of the thumbnails, the control unit can play digital media from a part corresponding to the touched thumbnail among the stored data.

To further achieve these and other advantages and in accordance with the purpose of the present invention, according to a different embodiment, a method of controlling a bended display device, which includes a bended display containing a main region facing the front side of the device and a sub-region having a prescribed curvature in a manner of being extended from the main region and a tilt sensor capable of sensing a posture of the device, includes the steps of displaying information on an event (hereinafter, event information), which is generated in the middle of executing an application for displaying a screen on the main region, on the sub-region, monitoring the posture of the device via the tilt sensor, and controlling the scroll speed of the event information displayed on the sub-region in a manner of associating the scroll speed with the posture of the device.

### Advantageous Effects

According to one embodiment of the present specification, it is able to control the scroll speed of event information displayed on a sub-region according to an action of a user. Hence, it is able to quickly forward information on the interest of the user.

According to a different embodiment of the present specification, when a user is interested in a sub-region, it is able to make the user obtain information on the interest of the user without any interruption by pausing or muting information displayed on a main region.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective diagram for a bended display device according to one embodiment of the present specification;

FIG. 2 is a schematic block diagram for configurations of a bended display device according to the present specification;

FIG. 3 is a schematic block diagram for configurations capable of being further included in a bended display device according to the present specification;

FIG. 4 is a diagram for an example of displaying information on an event, which has occurred in the middle of executing an application for displaying a screen on a main region of a bended display, on a sub-region;

FIG. 5 is a diagram for an example of tilting a device to more closely watch event information displayed on a sub-region;

FIG. 6 is a diagram for an example of controlling the scroll of event information by touching a sub-region;

FIG. 7 is a diagram for an example of moving content of event information by sweeping a sub-region while the sub-region is touched;

FIG. 8 is a diagram for an example of restoring a posture of a device to an original position;

FIGS. 9 and 10 are diagrams for an example that an application for displaying a screen on a main region corresponds to an application for playing digital media using real-time data received from the external;

FIG. 11 is a schematic flowchart for an algorithm of a control method according to one embodiment of the present specification;

FIG. 12 is a schematic flowchart for an algorithm of a control method according to a different embodiment of the present specification;

FIG. 13 is a schematic flowchart for an algorithm of a control method according to a further different embodiment of the present specification;

FIG. 14 is a schematic flowchart for an algorithm of a control method according to a further different embodiment of the present specification;

FIG. 15 is a schematic flowchart for an algorithm of a control method according to a further different embodiment of the present specification;

FIG. 16 is a schematic flowchart for an algorithm of a control method according to a further different embodiment of the present specification.

### BEST MODE

Reference will now be made in detail to the preferred embodiments of the present invention, examples of which are illustrated in the accompanying drawings. While embodiments are concretely described with reference to the attached diagrams and the contents written on the diagrams, the present specification may be non-restricted or non-limited to the embodiments.

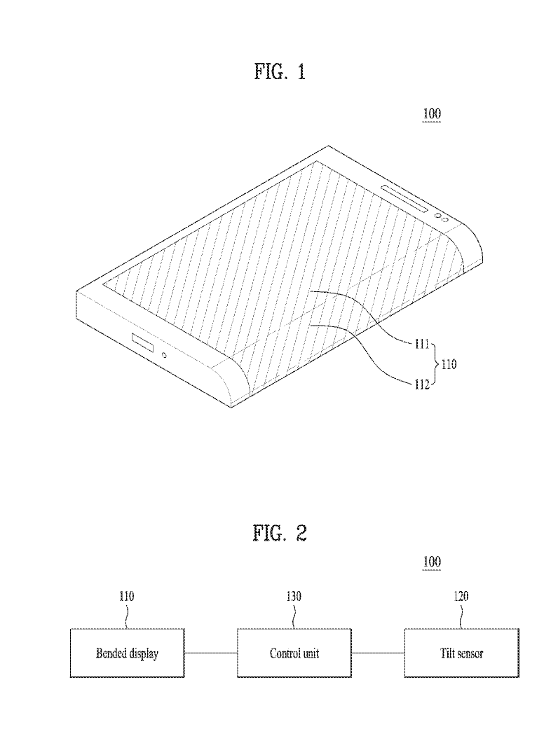

FIG. 1 is a perspective diagram for a bended display device according to one embodiment of the present specification.

Referring to FIG. 1, it is able to check a bended display 110 included in a device 100 according to the present specification. The bended display 110 includes a main region 111 facing the front side of the device 100 and a sub-region 112 having a prescribed curvature in a manner of being extended from the main region 111.

In the embodiment shown in FIG. 1, although the sub-region 112 is positioned at the right side of the device on the basis of the front side of the device 100 for example, the bended display 110 according to the present specification can be implemented in various shapes. For example, the sub-region 112 can be positioned at one side among the left side, the upper side, and the lower side. The bended display 110 may have the sub-region 112 positioned at least two positions selected from the group consisting of the right side, the left side, the upper side, and the lower side.

Since the bended display 110 uses a plastic board rather than a generally used glass plate, the bended display can be formed using a processor manufactured in low temperature instead of a legacy processor to prevent damage of the board. The bended display 110 provides flexibility capable of being folded and unfolded by replacing a glass plate around liquid crystal of an LCD (liquid crystal display), an LED (light emitting diode), an OLED (organic LED), and an AMOLED (active matrix OLED) with a plastic film. The bended display 110 is thin, light, and shock-resistant. Moreover, as mentioned in the foregoing description, since the bended display is bendable and foldable, it may be able to manufacture the bended display in various shapes.

The bended display 110 may have an active matrix screen of a specific screen size (e.g., 3 inches, 4 inches, 4.65 inches, 4.8 inches, 5 inches, 6.5 inches, 7.7 inches, 8.9 inches, 10.1 inches, etc.) depending on a size of the device 100. The sub-region 112 can be connected with the device 100 in a manner that the curvature of the sub-region 112 is folded with a radius of curvature equal to or less than a radius of curvature (e.g., radius of curvature 5 cm, 1 cm, 7.5 mm, 5 mm, 4 mm, etc.) in which the bended display 110 is operable.

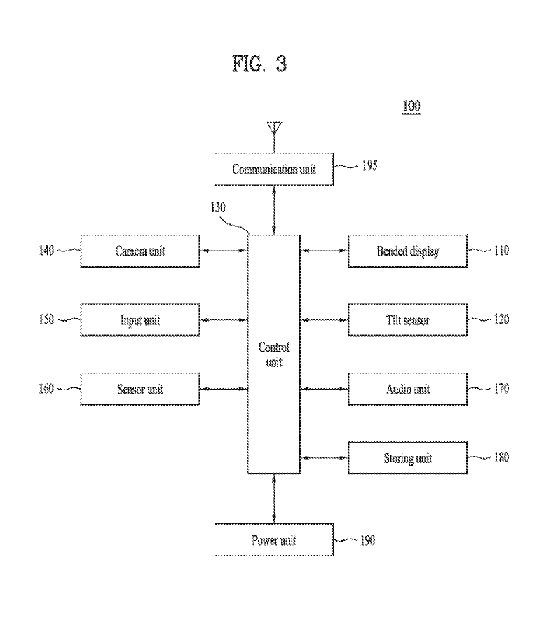

FIG. 2 is a schematic block diagram for configurations of a bended display device according to the present specification.

Referring to FIG. 2, a device 100 according to the present specification includes a bended display 110, a tilt sensor 120, and a control unit 130.

Since the bended display 110 has already been explained with reference to FIG. 1, explanation on the bended display is omitted at this time.

The tilt sensor 120 can sense a posture of the device 100. The posture of the device 100 shows the degree of tilting of the device 100 on the basis of gravity direction, a direction at which the device is facing on the basis of terrestrial magnetism, whether the device 100 is in a stationary state or a rotating state, or whether the device 100 is put in vertical direction or horizontal direction.

In order to sense the posture of the device 100, the tilt sensor 120 can forward information to the control unit using one or more sensors mounted on the device 100. The sensor can include a gravity sensor, a terrestrial magnetism sensor, a motion sensor, a gyro sensor, an acceleration sensor, and the like. Unless the tilt sensor 120 according to the present specification is restricted to the listed sensors, it is necessary to comprehend as all sensors capable of being easily used by a person having common knowledge in a technical field to which the present specification belongs thereto at the time of issuing the present specification are included.

The control unit 130 can control a function of the device 100. In particular, the control unit 130 can display information on an event (hereinafter, event information), which occurs in the middle of executing an application for displaying a screen on the main region 111, on the sub-region 112. In particular, the control unit can display and manage the function of the device 100 using the sub-region 112. In this case, the event information displayed on the sub-region 112 may correspond to information related to the application for displaying the screen on the main region 111 or information irrespective of the application for displaying the screen on the main region 111. For example, the information related to the application for displaying the screen on the main region 111 may correspond to various informations such as pop-up information corresponding to the application, attachment information, status information, control information, and the like. If it is necessary to control the screen displayed on the main region 111, it may be able to control a function for the screen by operating the sub-region 112. On the contrary, for example, the information irrespective of the application for displaying the screen on the main region 111 may correspond to information for notifying data in response to message reception (e.g., SMS (short message service)/MMS (multimedia message service) based message reception), mail reception, information reception of a push service, notification reception of a social network service (SNS), and the like, or information for notifying status information (e.g., charging state of a battery, notification of data clipped by a user, indicator, etc.) of the device 100.

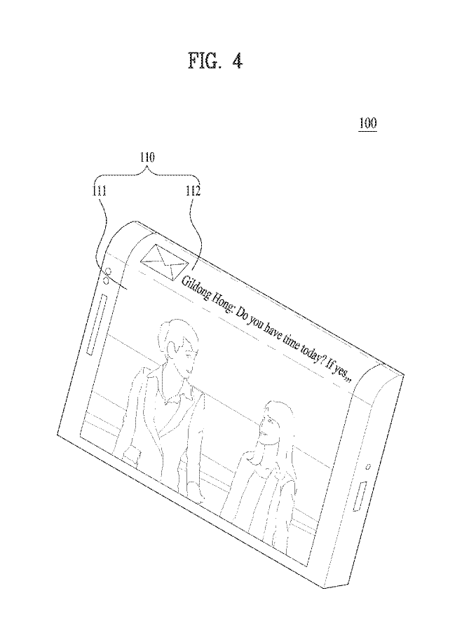

FIG. 3 is a schematic block diagram for configurations capable of being further included in a bended display device according to the present specification.

Referring to FIG. 3, a device 100 according to the present specification can further include at least one selected from the group consisting of a communication unit 195, a camera unit 140, an input unit 150, a sensor unit 160, an audio unit 170, a storing unit 180, and a power unit 190.

In the present specification, a bended display device 100 includes the bended display 110 and corresponds to a device of various types capable of processing digital data and performing an operation corresponding to the digital data. As the performance of the device is enhanced, it may be able to execute various contents via the device. For example, the device can include a TV, a laptop computer, a desktop computer, a monitor, a smartphone, a tablet PC, a navigator, a PMP, a terminal for payment, a terminal for security, a kiosk, and the like. In particular, a widely used portable device is utilized as a player of comprehensive multimedia contents.

The communication unit 195 performs communication with an external digital device using various protocols to transceive data with the external device.

The external digital device may correspond to a mobile terminal or a fixed terminal. Examples of the mobile terminal include a cellular phone, a smartphone, a tablet PC (personal computer), a smart pad, a notebook, a digital broadcasting terminal, a PDA (personal digital assistants), a PMP (portable multimedia player), digital camera, a navigation, and the like. Examples of the fixed terminal include a desktop, a DVD (digital video disc or digital versatile disc) player, a TV, and the like.

The various protocols include a wired and a wireless communication protocols. In case of performing wired communication, the communication unit 195 can include various input/output interfaces (not depicted) capable of performing data transmission communication with the external digital device. For example, the interface can include an interface considering data transmission according to USB (universal serial bus) standard, HDMI (high definition multimedia interface), DVI (digital visual interface), IEEE 1394 standard, or a similar standard associated with data transmission. In case of performing wireless communication, the communication unit 195 can include an RF electrical network considering wireless access to an external communication network such as the internet, LAN (local area network), WAN (wide area network), and the like. A wireless communication network accessed by the communication unit 195 can support such a mobile communication scheme as GSM (Global System for Mobile Communications), EDGE (Enhanced Data GSM Environment, CDMA (Code Division Multiple Access), W-CDMA (Wideband Code Division Multiple Access), TDMA (Time Division Multiple Access), Wibro, HSPA (High Speed Packet Access), HSDPA (High Speed Downlink Packet Access), LTE (Long Term Evolution), and the like and such a short range communication scheme as Bluetooth, RFID (Radio Frequency Identification), IrDA, (infrared Data Association), UWB (Ultra Wideband), ZigBee, WLAN (Wireless LAN)(Wi-Fi), and the like.

In this case, the wired/wireless interface schemes correspond to embodiments for helping understand the present specification. Since those skilled in the art can easily change an interface scheme for transmitting/receiving information, in the present specification, an interface scheme is not restricted to the aforementioned embodiments.

The camera unit 140 captures a surrounding image of the digital device 100 and converts the image into an electrical signal. To this end, the camera unit 140 can include an image sensor. The image sensor can convert an optical signal into an electrical signal. After the image is captured by the camera unit 140 and is converted into the electrical signal, the image is stored in the storage unit 180 and can be outputted to the control unit 130. Or, the image can be outputted to the control unit 130 without being stored in the storage unit. The image captured by the camera unit 140 may correspond to a still image or a video. The camera unit 140 can also be used as a motion sensor or a video sensor. If necessary, the camera unit 140 can include a plurality of cameras.

The input unit 150 can receive a user command from the external. The input unit 150 can be implemented in various ways. For example, the input unit 150 can be implemented by a keyboard, a keypad, a mouse, a touch pad, a button, a soft key, and the like. In a broad sense, the input unit 150 can include a microphone, a touch screen, and the like. The microphone can receive a voice input of a user and the touch screen can receive a touch gesture of the user. In some cases, the microphone can be included in the audio unit 170.

The sensor unit 160 detects surrounding environment of the digital device 100 using at least one sensor mounted on the digital device 100 and can forward the detected information to the control unit 130. And, the sensor unit 160 senses a user input and can forward the user input to the control unit 130. In this case, the sensor unit 160 can include at least one sensing means. For example, the sensing means can include various sensing means including an infrared sensor, an inclination sensor, a brightness sensor, an altitude sensor, a smell sensor, a temperature sensor, a depth sensor, a pressure sensor, a bending sensor, an audio sensor, a video sensor, a GPS (global positioning system) sensor, a touch sensor, a fingerprint sensor, and the like. The sensor unit 160 is a common name for the aforementioned various sensing means. The sensor unit senses various inputs of a user and environment of the user and forwards a sensed result to the control unit 130 to make the control unit perform an operation according to the sensed result. The sensing means can be included in the digital device 100 as a separate element or can be included in the digital device in a manner of being integrated using at least one or more elements.

The audio unit 170 can include an audio output means such as a speaker and the like and an audio input means such as a microphone and the like. The audio output means can output an audio signal of contents executed in the digital device 100. The contents can be received from the storing unit 180 or can be received from the external digital device 100 via the communication unit 195. The audio output means can include at least one of an air conduction speaker and a bone conduction speaker.

The storing unit 180 can store various digital data including a video, an audio, a picture, an application, and the like. The application may correspond to a program for operating the control unit 130. And, the video or the picture may correspond to data captured by the camera unit 140. The storing unit 180 can be configured through a RAM (Random Access Memory), an SRAM (Static Random Access Memory), a ROM (Read Only Memory), an EEPROM (Electrically Erasable Programmable Read Only Memory), a PROM (Programmable Read Only Memory), and the like. The storing unit 180 can perform the storing function in a manner of being associated with web storage on the Internet. The storing unit 180 can further include an external storing media capable of being removed from the digital device 100. The external storing media may have a slot form such as an SD (secure digital) or a CF (compact flash) memory, a memory stick form, a USB (universal serial bus) form, and the like. In particular, the external storing media can include all storing media capable of being removed from the digital device 100 and providing contents such as an audio, a picture, a video, an application, and the like to the digital device 100. For example, the storing unit 180 can include a RAM, a ROM, a cache memory, a HDD (hard disk drive), an SSD (solid state drive), a CD, a DVD, a Blu-ray disk, an FDD (floppy disc drive), a magnetic disk, a memory card, a flash memory, a USB memory, and the like.

The power unit 190 corresponds to a power source connected to a battery or an external power source and can provide power to a device. The battery includes not only a primary batter but also a secondary battery. The secondary battery includes a rechargeable lithium-ion battery, a lithium polymer battery, a nickel-cadmium battery, a nickel-hybrid battery, a nickel-zinc battery, and the like.

Besides the aforementioned roles, the control unit 130 can execute contents stored in the storing unit 180, contents received via data communication, or the like. The control unit 130 executes various applications and processes internal data of the digital device 100. The control unit 130 controls each of the configurations of the digital device 100 and controls data communication to be performed between configurations. In order to execute control logic to be explained in detail in the following, the control unit 130 can include a processor well known to a technical field to which the present invention belongs thereto, ASIC (application-specific integrated circuit), other chipset, a logical circuit, a register, a communication modem, a data processing device, and the like. When the control logic is implemented by software, the control unit 130 can be implemented by a set of program modules. In this case, the program modules are stored in the storing unit 180 and can be executed by the processor.

The control unit 130 according to the present specification can control the scroll speed of event information displayed on the sub-region 112 in a manner of associating the scroll speed with a posture of the device 100 sensed by the inclination sensor 120. As mentioned in the foregoing description, the event information can be displayed on the sub-region 112. In this case, if a user is interested in the information displayed on the sub-region 112, the user may want to more closely watch the information displayed on the sub-region 112. To this end, the user may tilt the device 100 to make the sub-region of the device 100 to be positioned at the front side of a gaze of the user.

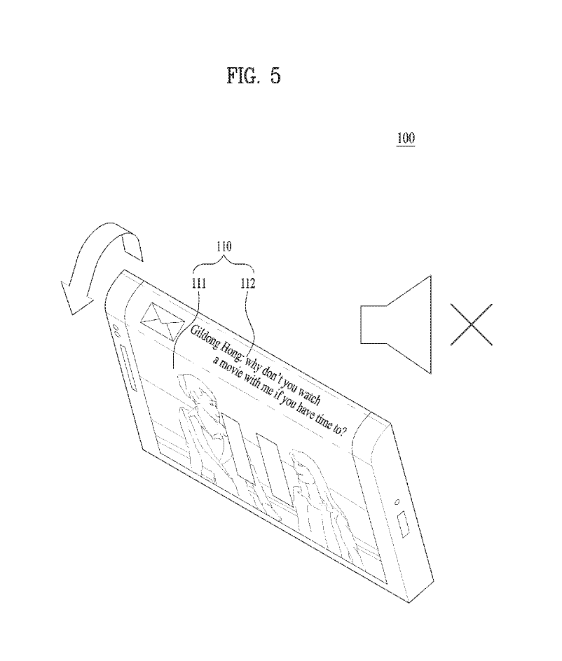

In the following, control logic of the control unit 130 according to the present specification is explained in more detail with reference to FIGS. 4 to 10.

FIG. 4 is a diagram for an example of displaying information on an event, which has occurred in the middle of executing an application for displaying a screen on a main region of a bended display, on a sub-region.

FIG. 4 shows a situation that the control unit 130 receives a message while playing and displaying a video on the main region 111 and displays the message on the sub-region 112 as event information.

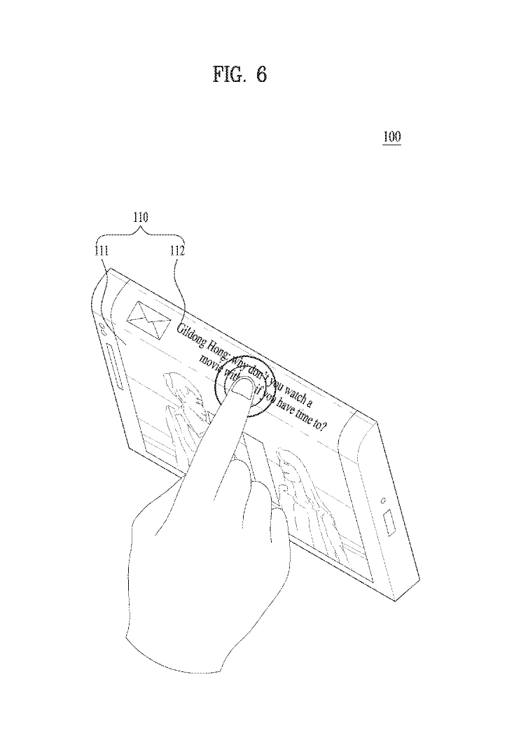

FIG. 5 is a diagram for an example of tilting a device to more closely watch event information displayed on a sub-region.

When a posture of the device is tilted in a manner that a direction to which the sub-region 112 is facing is tilted to a direction at which the main region 111 is facing, the control unit 130 according to the present specification can increase the scroll speed of the event information displayed on the sub-region 112. If a user of the device 100 recognizes that the event information is displayed on the sub-region 112, the user may want to more closely watch the event information displayed on the sub-region 112. Since the sub-region 112 has a prescribed curvature, in order for the user to more closely watch the sub-region 112, the user may tilt the device 100 to make the sub-region 112 to be positioned at the front side of a gaze of the user. In this case, the control unit 130 can sense that the posture of the device 100 is tilted via the tilt sensor 120. As shown in FIG. 5, if the posture of the device 100 is tilted, it can be determined as the user intends to more closely watch the sub-region 112.

Moreover, the control unit 130 can increase the scroll speed in proportion to a tilted level of the posture of the device 100. In particular, the more the device is tilted, the more the scroll speed increases.

On the contrary, when the direction at which the main region 111 is facing is tilted to the direction at which the sub-region is facing, the control unit 130 can decrease the scroll speed of the event information displayed on the sub-region 112.

Meanwhile, the event information displayed on the sub-region 112 may or may not be scrolled on the sub-region 112 at the time of generating the event information. Preferably, the control unit 130 according to the present specification can start to scroll the event information displayed on the sub-region 112 when the posture of the device is tilted in a manner that the direction at which the sub-region 112 is facing is tilted to the direction at which the main region 111 is facing.

According to the embodiment of the present specification, the control unit 130 can scroll the event information displayed on the sub-region 112 in a direction orthogonal to a direction to which the posture of the device 100 is tilted when the posture of the device is tilted in a manner that the direction at which the sub-region 112 is facing is tilted to the direction at which the main region 111 is facing.

According to one embodiment of the present specification, if an application for displaying a screen on the main region 111 corresponds to an application for playing a digital media, the control unit 130 can reduce a volume of the digital media from the timing at which the posture of the device sensed by the tilt sensor 120 is tilted.

According to a different embodiment of the present specification, if an application for displaying a screen on the main region 111 corresponds to an application for playing a digital media, the control unit 130 can stop playing the digital media from the timing at which the posture of the device sensed by the tilt sensor is tilted.

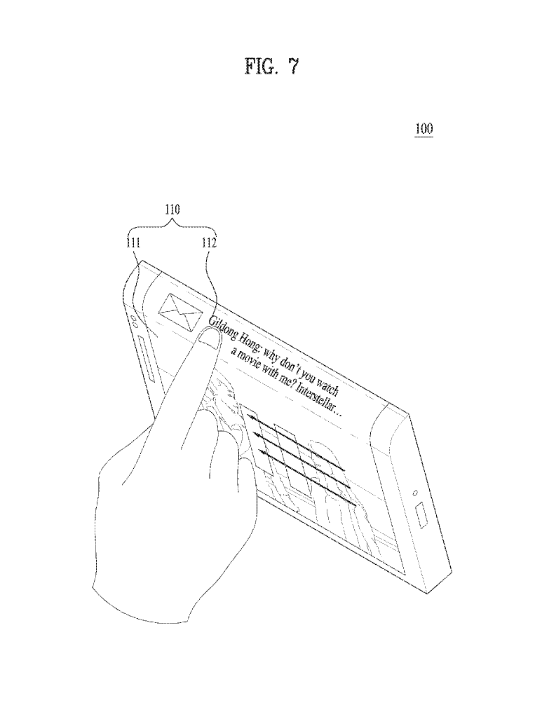

FIG. 6 is a diagram for an example of controlling the scroll of event information by touching a sub-region.

Referring to FIG. 6, it is able to see that a user touches the sub-region 112. According to the embodiment of the present specification, the sensor unit 160 can be mounted on the bended display 110. Hence, the control unit 130 can detect various user inputs inputted on the bended display 110 via the sensor unit 160. For example, if the sensor unit 160 includes a touch sensor, the control unit 130 can receive various touch inputs of the user inputted on the bended display 110. In particular, in the present specification, the bended display 110 of the device 100 may correspond to a touch screen.

In this case, the bended display 110 senses a contact of a user and can output an input signal to the control unit 130. If the user touches the sub-region 112 while the event information displayed on the sub-region 112 is scrolled, the control unit 130 can stop scrolling the event information displayed on the sub-region 112. By doing so, when the event information displayed on the sub-region 112 is scrolled, the user temporarily stops the scrolling and may be able to check important information in detail.

According to one embodiment of the present specification, if a user maintains a touch touched on the sub-region 112, the control unit 130 can maintain the scroll of the event information displayed on the sub-region 112 in a stop state.

According to a different embodiment of the present specification, if the user stops scrolling the event information displayed on the sub-region 112 and then touches the sub-region 112 again, the control unit 130 can control the scroll of the event information displayed on the sub-region 112 to be started again.

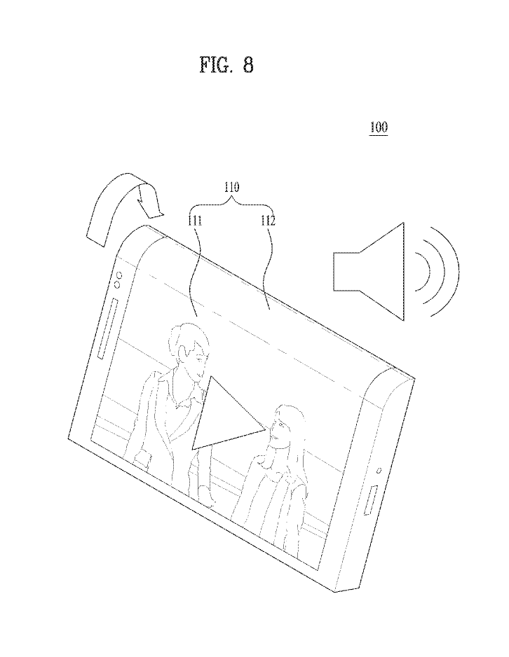

FIG. 7 is a diagram for an example of moving content of event information by sweeping a sub-region while the sub-region is touched.

Referring to FIG. 7, a user sweeps a touch in the left direction in a state that the user maintains the touch touched on the sub-region 112.

According to a further different embodiment of the present specification, when the user sweeps the touch in a direction in a state that the user maintains the touch touched on the sub-region 112, the control unit 130 can control contents of the event information displayed on the sub-region 112 to be moved in the direction to which the touch is swept. The user can more quickly move to content preferred by the user among the contents of the event information via the sweeping.

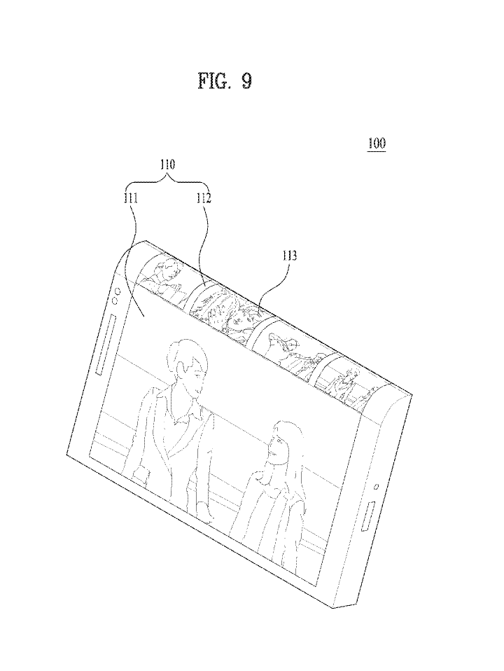

FIG. 8 is a diagram for an example of restoring a posture of a device to an original position.

According to a different embodiment of the present specification, if the posture of the device 100 is returned to the posture at the time of generating the event information, the control unit 130 can stop displaying the event information displayed on the sub-region 112. If a user changes the posture of the device 100 to an original position, it can be comprehended as the user has checked all of the event information displayed on the sub-region 112.

Meanwhile, an application for displaying a screen on the main region 111 may correspond to an application for playing digital media. According to one embodiment of the present specification, if the posture of the device 100 is returned to the posture at the time of generating the event information, the control unit 130 can make a volume of the digital media to be returned to an original volume. According to a different embodiment of the present specification, the control unit 130 can play the digital media again.

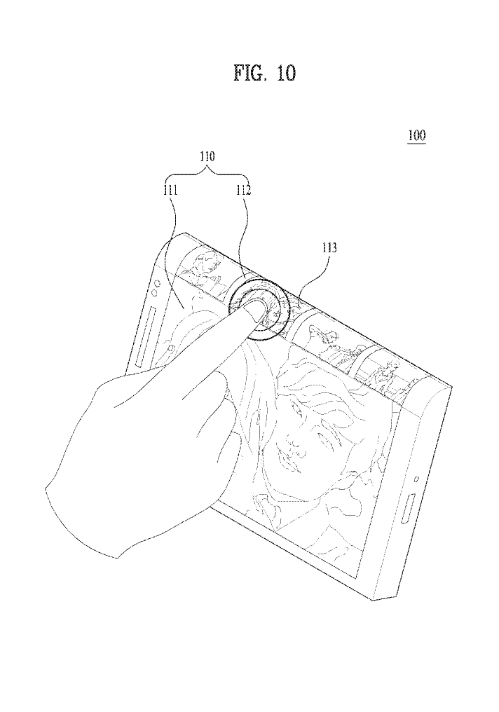

FIGS. 9 and 10 are diagrams for an example that an application for displaying a screen on a main region corresponds to an application for playing digital media using real-time data received from the external.

In the examples mentioned earlier in FIGS. 4 to 8, it is assumed that an application for displaying a screen on the main region 111 plays digital media stored in the storing unit 180. Hence, the control unit 130 can stop playing the digital media or play the digital media again. Moreover, a user does not fail to lose sound or a screen of the digital media while checking the event information displayed on the sub-region 112 via the pause of the digital media. Yet, the application for displaying a screen on the main region 111 may correspond to an application for playing digital media using real-time data received from the external. For example, the real-time data may correspond to a streaming data or DMB data provided by an external server. In this case, the user may fail to lose sound or a screen of the digital media while checking the event information displayed on the sub-region 112.

According to the embodiment of the present specification, if an application for displaying a screen on the main region 111 corresponds to an application for playing digital media using real-time data received from the external, the control unit 130 can store the data of the digital media received in real-time from the timing at which a posture of the device 100 sensed by the tilt sensor 120 is tilted. In this case, the control unit 130 can store the data of the digital media received in real time in the storing unit 180. The control unit 130 can terminate the storing of the data when the posture of the device 100 is returned to a posture at the timing of generating the event information.

Moreover, the control unit 130 can display information related to the stored data on the sub-region 112. In this case, if the stored data includes images, the control unit 130 can display at least one of the stored images on the sub-region 112 as a thumbnail. Preferably, the thumbnail corresponds to a plurality of thumbnails arranged at the sub-region 112 according to the passage of time. Referring to the example shown in FIG. 9, it may be able to check 4 thumbnails displayed on the sub-region 112. The 4 thumbnails correspond to thumbnails for a digital media received in real time between the timing at which the posture of the device 100 is tilted and the timing at which the posture of the device is returned to the original posture (i.e., while the user checks the event information displayed on the sub-region 112). The control unit 130 can generate a thumbnail image file by selecting an image of a core part from the data of the digital media received and stored in real time. The image selected from the stored digital media can be selected in various ways.

Subsequently, as shown in FIG. 10, if a user touches a thumbnail from among a plurality of thumbnails, the control unit 130 can play the digital media from a part corresponding to the touched thumbnail among the stored data.

In the following, a method of controlling the aforementioned bended display device 100 is explained. In explaining the control method according to the present specification, since each of the configurations of the bended display device 100 has already been explained in detail, overlapped explanation is omitted at this time.

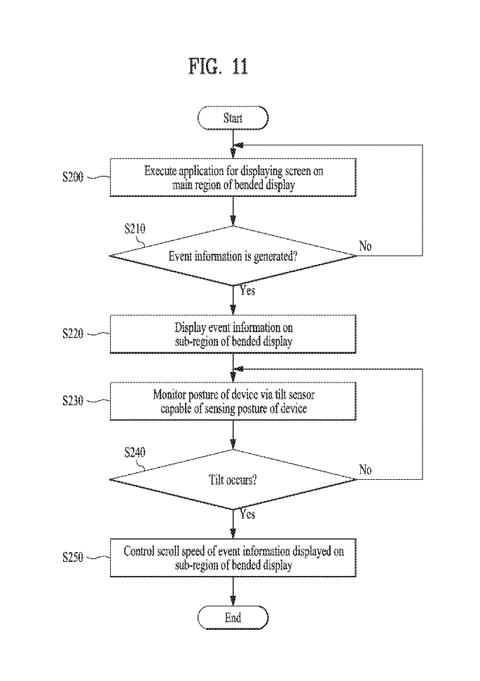

FIG. 11 is a schematic flowchart for an algorithm of a control method according to one embodiment of the present specification.

Referring to FIG. 11, in the step S200, the control unit 130 executes an application for displaying a screen on the main region 111 of the bended display 110. The control unit 130 controls the processor to move to the step S210 from the step S200.

In the step S210, the control unit 130 determines whether or not event information is generated. If the event information is not generated (‘no’ in the step S210), the control unit 130 controls the processor to move to the step S200. Hence, the control unit 130 repeatedly executes the steps S200 and S210. On the contrary, if the event information is generated (‘yes’ in the step S210), the control unit 130 controls the processor to move to the step S220.

In the step S220, the control unit 130 displays the event information on the sub-region 112 of the bended display 110. The control unit 130 controls the processor to move to the step S230 from the step S220.

In the step S230, the control unit 130 monitors a posture of the device 100 via a tilt sensor 120 capable of sensing the posture of the device 100. The control unit 130 controls the processor to move to the step S240 from the step S230.

In the step S240, the control unit 130 determines whether or not the posture of the device 100 is tilted. If the posture of the device 100 is not tilted (‘no’ in the step S240), the control unit 130 controls the processor to move to the step S230. Hence, the control unit 130 repeatedly executes the steps S230 and S240. On the contrary, if the posture of the device 100 is tilted (‘yes’ in the step S240), the control unit 130 controls the processor to move to the step S250.

In the step 150, the control unit 130 controls the scroll speed of the event information displayed on the sub-region 112 of the bended display 110.

According to one embodiment of the present specification, in the step S250, if the posture of the device 100 is tilted in a manner that a direction at which the sub-region 112 is facing is tilted to a direction at which the main region 111 is facing, the control unit 130 can increase the scroll speed of the event information displayed on the sub-region 112. In this case, the control unit 130 can increase the scroll speed in proportion to a tilted level of the posture of the device 100. On the contrary, when the direction at which the main region 111 is facing is tilted to the direction at which the sub-region is facing, the control unit 130 can decrease the scroll speed of the event information displayed on the sub-region 112.

According to a different embodiment of the present specification, in the step S250, if the posture of the device 100 is tilted in a manner that a direction at which the sub-region 112 is facing is tilted to a direction at which the main region 111 is facing, the control unit 130 can control the scroll of the event information displayed on the sub-region 112 to be started.

Meanwhile, an application for displaying a screen on the main region 111 may correspond to an application for playing digital media. In this case, the control unit 130 can reduce a volume of the digital media from the timing at which the posture of the device 100 sensed by the tilt sensor 120 is tilted. And, the control unit 130 can control the playback of the digital media to be stopped from the timing at which the posture of the device 100 sensed via the tilt sensor 120 is tilted. On the contrary, since the aforementioned embodiments are explained with explained through FIGS. 5 and 8, overlapped explanation is omitted at this time.

Meanwhile, if the posture of the device 100 is tilted in a manner that the direction at which the sub-region 112 is facing is tilted to the direction at which the main region 111 is facing, the control unit 130 can control the scroll direction of the event information displayed on the sub-region 112 to be orthogonal to the direction to which the posture of the device 100 is tilted.

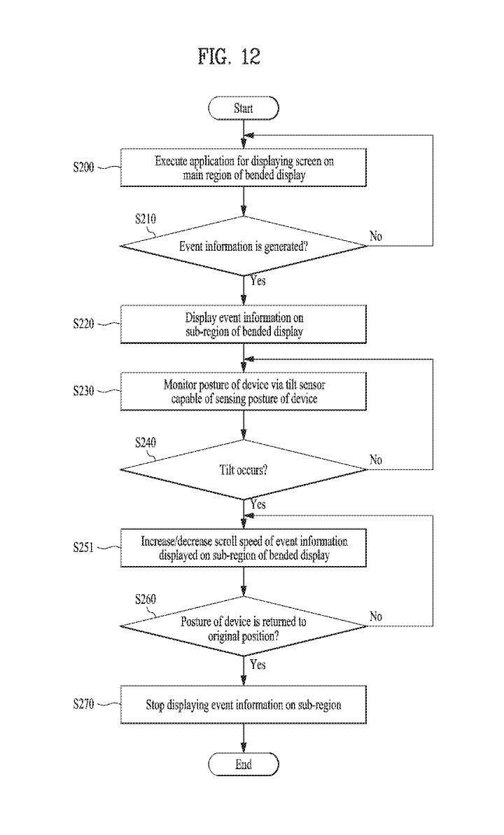

FIG. 12 is a schematic flowchart for an algorithm of a control method according to a different embodiment of the present specification.

Referring to FIG. 12, it is able to see that contents of the steps S200 to S240 are identical to the contents of FIG. 11. Hence, the step S251 having a difference from the embodiment shown in FIG. 11 is explained first.

In the step S251, the control unit 130 can control the scroll speed of the event information displayed on the sub-region 112 of the bended display 110 to be increased or decreased. The control unit 130 controls the processor to move to the step S260 from the step S251.

In the step S260, the control unit 130 determines whether or not the posture of the device 100 is returned to a posture at the time of generating the event information. If the posture of the device 100 is not returned (‘no’ in the step S260), the control unit 130 controls the processor to move to the step S270. Hence, the control unit 130 repeatedly executes the steps S251 and S260. On the contrary, if the posture of the device 100 is returned (‘yes’ in the step S260), the control unit 130 controls the processor to move to the step S270.

In the step S270, the control unit 130 can stop displaying the event information displayed on the sub-region 112. And, the control unit 130 ends the processor.

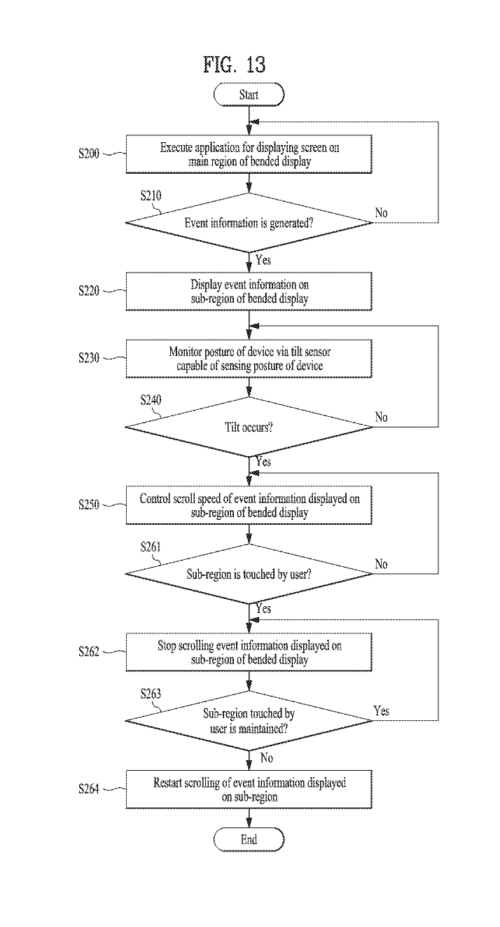

FIG. 13 is a schematic flowchart for an algorithm of a control method according to a further different embodiment of the present specification.

Referring to FIG. 13, it is able to see that contents of the steps S200 to S250 are identical to the contents of FIG. 11. Hence, the step S261 having a difference from the embodiment shown in FIG. 11 is explained first.

In the step S261, the control unit 130 determines whether or not a user touches the sub-region 112. If the user does not touch the sub-region (‘no’ in the step S261), the control unit 130 controls the processor to move to the step S250. Hence, the control unit 130 repeatedly executes the steps S250 and S261. On the contrary, if the user touches the sub-region (‘yes’ in the step S261), the control unit 130 controls the processor to move to the step S262.

In the step S262, the control unit 130 controls the scroll of the event information displayed on the sub-region 112 to be stopped. The control unit 130 controls the processor to move to the step S263 from the step S262.

In the step S263, the control unit 130 determines whether or not the user maintains a touch touching the sub-region 112. If the user maintains the touch (‘yes’ in the step S261), the control unit 130 controls the processor to move to the step S262. Hence, the control unit 130 repeatedly executes the steps S262 and S263. On the contrary, if the user does not maintain the touch (‘no’ in the step S263), the control unit 130 controls the processor to move to the step S264.

In the step S264, the control unit 130 controls the scroll of the event information displayed on the sub-region 112 to be started again. And, the control unit 130 ends the processor. Since the method described in FIG. 13 is explained in detail with reference to FIG. 6, overlapped explanation is omitted at this time.

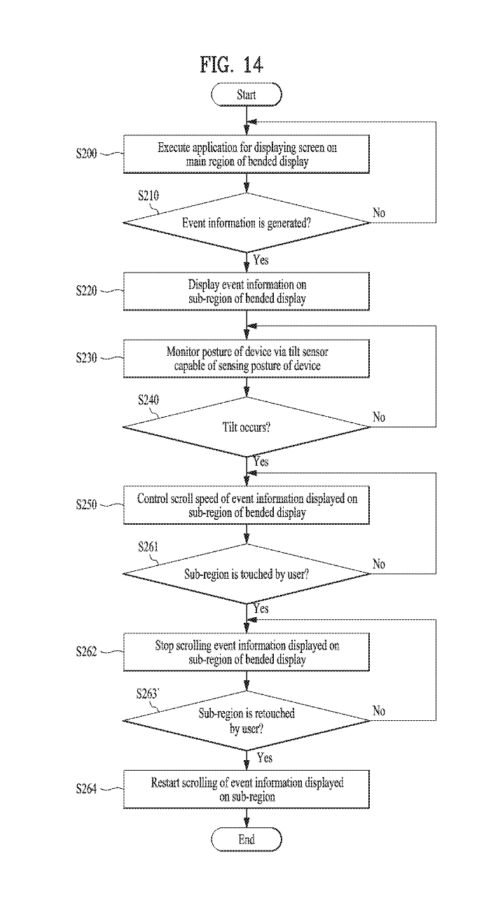

FIG. 14 is a schematic flowchart for an algorithm of a control method according to a further different embodiment of the present specification.

Referring to FIG. 14, it is able to see that contents of the steps S200 to S262 and contents of the step S264 are identical to the contents of FIG. 13. Hence, the step S263′ having a difference from the embodiment shown in FIG. 13 is explained first.

In the step S263′, the control unit 130 determines whether or not a user retouches the sub-region 112. If the user does not retouch the sub-region (‘no’ in the step S263), the control unit 130 controls the processor to move to the step S262. Hence, the control unit 130 repeatedly executes the steps S262 and S263′. On the contrary, if the user retouches the sub-region (‘yes’ in the step S263′), the control unit 130 controls the processor to move to the step S264. Since the step S264 has already been explained, overlapped explanation is omitted at this time.

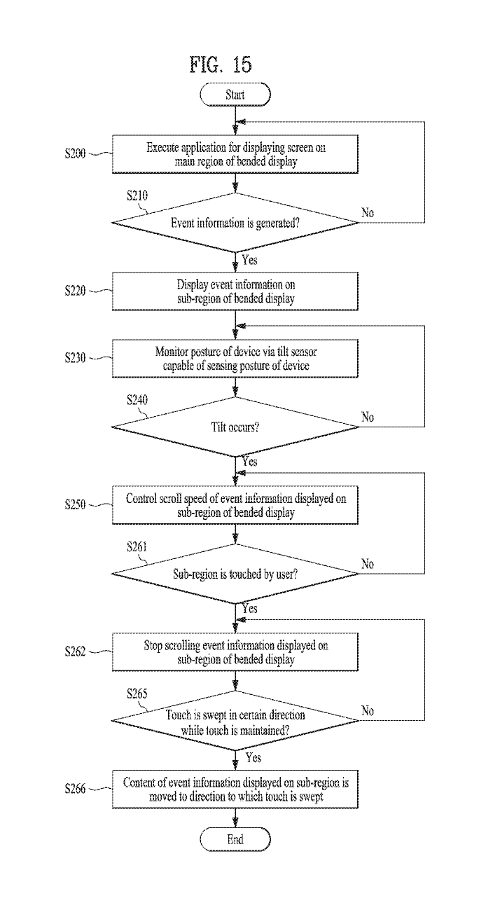

FIG. 15 is a schematic flowchart for an algorithm of a control method according to a further different embodiment of the present specification.

Referring to FIG. 15, it is able to see that contents of the steps S200 to S262 are identical to the contents of FIG. 13. Hence, the step S265 having a difference from the embodiment shown in FIG. 13 is explained first.

In the step S265, the control unit 130 determines whether or not a user sweeps a touch in a direction while If the user does not sweep the touch (‘no’ in the step S265), the control unit 130 controls the processor to move to the step S262. Hence, the control unit 130 repeatedly executes the steps S262 and S265. On the contrary, if the user sweeps the touch (‘yes’ in the step S265), the control unit 130 controls the processor to move to the step S266.

In the step S264, the control unit 130 controls contents of the event information displayed on the sub-region 112 to move to the direction in which the touch is swept. And, the control unit 130 ends the processor.

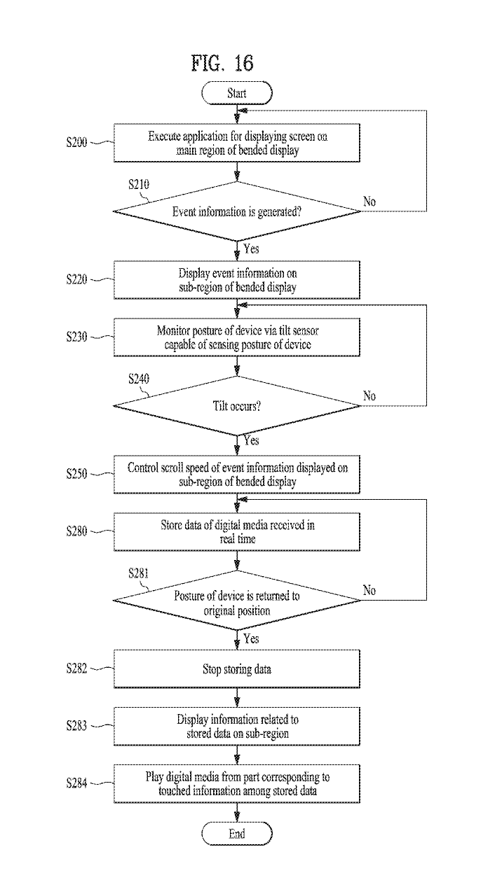

FIG. 16 is a schematic flowchart for an algorithm of a control method according to a further different embodiment of the present specification.

Referring to FIG. 16, it is able to see that contents of the steps S200 to S250 are identical to the contents of FIG. 11. Hence, the step S280 having a difference from the embodiment shown in FIG. 11 is explained first.

In the step S280, if an application for displaying a screen on the main region 111 corresponds to an application for playing digital media using a real-time data received from the external, the control unit 130 stores the data of the digital media received in real time from the timing at which a posture of the device sensed via the tilt sensor 120 is tilted. The control unit 130 controls the processor to move to the step S281 from the step S268.

In the step S281, the control unit 130 determines whether or not the posture of the device 100 is returned to the posture at the time of generating the event information. If the posture of the device is not returned (‘no’ in the step S281), the control unit 130 controls the processor to move to the step S280. Hence, the control unit 130 repeatedly executes the steps S280 and S281. On the contrary, if the posture of the device is returned (‘yes’ in the step S281), the control unit 130 controls the processor to move to the step S282.

In the step S282, the control unit 130 terminates the storing of the data. And, the control unit 130 controls the processor to move to the step S283 from the step S282.

In the step S283, the control unit 130 displays information related to the stored data on the sub-region. According to the embodiment of the present specification, if the stored data includes images, at least one of the stored images can be displayed on the sub-region as a thumbnail. The thumbnail may correspond to a plurality of thumbnails arranged at the sub-region 112 according to the passage of time. The control unit 130 controls the processor to move to the step S284 from the step S283.

In the step S284, the control unit 130 plays the digital media from a part corresponding to touched information among the stored data. And, the control unit 130 ends the processor.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

Specific structural and functional description of the present specification respective to the exemplary embodiments, which are provided in accordance with the concept of the present specification disclosed in the present specification, is merely an exemplary description provided for the purpose of describing the exemplary embodiments according to the concept of the present specification. And, therefore, the exemplary embodiment of the present specification may be realized in diverse forms and structures, and, it should be understood that the present specification is not to be interpreted as being limited only to the exemplary embodiments of the present specification, which are described herein.

Since diverse variations and modifications may be applied to the exemplary embodiments according to the concept of the present specification, and, since the exemplary embodiments of the present specification may be configured in diverse forms, specific embodiment of the present specification will hereinafter be described in detail with reference to the examples presented in the accompanying drawings. However, it should be understood that the exemplary embodiments respective to the concept of the present specification will not be limited only to the specific structures disclosed herein. And, therefore, it should be understood that all variations and modifications, equivalents, and replacements, which are included in the technical scope and spirit of the present specification, are included.

In the present specification, a terminology, each of which includes such an ordinal number as 1^{st}, 2^{nd} and the like, may be used to describe various components. In doing so, the various components should be non-limited by the corresponding terminologies, respectively. The terminologies are only used for the purpose of discriminating one component from other components. For example, a first configuration element can be referred to as a second configuration element, similarly, the second configuration element can be referred to as the first configuration element while not being deviated from the scope of right according to the concept of the present specification.

In the present application, such a terminology as ‘comprise’, ‘include’ and the like should be construed not as excluding existence of a different configuration element but as designating further existence of a different configuration element. In this disclosure, such a terminology as ‘ . . . unit’, ‘ . . . part’ corresponds to a unit for processing at least one or more functions or operations. The unit can be implemented by a combination of hardware and/or software.

While the present specification has been described and illustrated herein with reference to the preferred embodiments thereof, it may be non-limited to the aforementioned specific embodiment and it will be apparent to those skilled in the art that various modifications and variations can be made therein without departing from the spirit and scope of the invention. Thus, it is intended that the technical idea and prospect of the present specification covers the modifications and variations of this invention.

In explaining the embodiments of the present specification, for clarity, an example of adding a single subordinate configuration is mainly explained. Yet, an embodiment of adding a combination of two or more subordinate configurations is also feasible. Hence, the scope of the present specification may be non-limited by the embodiments disclosed in the present specification.

### MODE FOR INVENTION

Various embodiments have been explained in the best mode for implementing the present specification. It is apparent to those skilled in the art that various modifications and changes can be made in the present invention without deviating from the idea and the scope of the present specification. Therefore, the present specification can include variations and changes provided within the range and a similar range of the attached claims.

### INDUSTRIAL APPLICABILITY

As mentioned in the foregoing description, all or a part of the present specification can be applied to electronic devices.

What is claimed is:

1. A bended display device, comprising:
a bended display containing a main region facing the front side of the device and a sub-region having a prescribed curvature in a manner of being extended from the main region;
a tilt sensor capable of sensing a posture of the device; and
a control unit configured to control a function of the device, the control unit configured to display information on an event (hereinafter, event information), which is generated in the middle of executing an application for displaying a screen on the main region, on the sub-region, the control unit configured to control the scroll speed of the event information displayed on the sub-region in a manner of associating the scroll speed with the posture of the device sensed via the tilt sensor.

2. The bended display device of claim 1, wherein if the posture of the device is tilted in a manner that a direction at which the sub-region is facing is tilted to a direction at which the main region is facing, the control unit is configured to increase the scroll speed of the event information displayed on the sub-region.

3. The bended display device of claim 2, wherein the control unit is configured to increase the scroll speed in proportion to a tilted level of the posture of the device.

4. The bended display device of claim 2, wherein if the direction at which the main region is facing is tilted to the direction at which the sub-region is facing, the control unit is configured to decrease the scroll speed of the event information displayed on the sub-region.

5. The bended display device of claim 1, wherein if the posture of the device is tilted in a manner that a direction at which the sub-region is facing is tilted to a direction at which the main region is facing, the control unit is configured to control the scroll of the event information displayed on the sub-region to be started.

6. The bended display device of claim 1, wherein if the posture of the device is tilted in a manner that a direction at which the sub-region is facing is tilted to a direction at which the main region is facing, the control unit is configured to control the event information displayed on the sub-region to be scrolled in a direction orthogonal to a direction in which the posture of the device is tilted.

7. The bended display device of claim 1, wherein the bended display is configured to output an input signal to the control unit by sensing a contact of a user and wherein if the user touches the sub-region while the event information displayed on the sub-region is scrolled, the control unit is configured to stop scrolling the event information displayed on the sub-region.

8. The bended display device of claim 7, wherein the control unit is configured to maintain the scroll of the event information displayed on the sub-region in a paused state while the user maintains the touch touched on the sub-region.

9. The bended display device of claim 7, wherein if the user retouches the sub-region after the scroll of the event information displayed on the sub-region is paused, the control unit is configured to control the scroll of the event information displayed on the sub-region to be started again.

10. The bended display device of claim 7, wherein if the user sweeps the touch in a certain direction while the touch touched on the sub-region is maintained, the control unit is configured to control contents of the event information displayed on the sub-region to move in the direction to which the touch is swept.

11. The bended display device of claim 2, wherein if the posture of the device is returned to a posture at the time of generating the event information, the control unit is configured to stop displaying the event information on the sub-region.

12. The bended display device of claim 1, wherein if the application for displaying the screen on the main region corresponds to an application for playing digital media, the control unit is configured to reduce a volume of the digital media from the timing at which the posture of the device sensed by the tilt sensor is tilted.

13. The bended display device of claim 1, wherein if the application for displaying the screen on the main region corresponds to an application for playing digital media, the control unit is configured to control the playback of the digital media to be stopped from the timing at which the posture of the device sensed by the tilt sensor is tilted.

14. The bended display device of claim 1, wherein if the application for displaying the screen on the main region corresponds to an application for playing digital media using real-time data received from the external, the control unit is configured to store the data of the digital media received in real-time from the timing at which the posture of the device sensed by the tilt sensor is tilted.

15. The bended display device of claim 14, wherein if the posture of the device is returned to a posture at the time of generating the event information, the control unit is configured to stop storing the data.

16. The bended display device of claim 15, wherein the control unit is configured to display information related to the stored data on the sub-region.

17. The bended display device of claim 16, wherein if the stored data comprises images, the control unit is configured to display at least one of the stored images on the sub-region as a thumbnail.

18. The bended display device of claim 17, wherein the thumbnail corresponds to a plurality of thumbnails arranged at the sub-region according to the passage of time.

19. The bended display device of claim 18, wherein the bended display is configured to output an input signal to the control unit by sensing a contact of a user and wherein if the user touches one of a plurality of the thumbnails, the control unit is configured to play digital media from a part corresponding to the touched thumbnail among the stored data.

20. A method of controlling a bended display device, which comprises a bended display containing a main region facing the front side of the device and a sub-region having a prescribed curvature in a manner of being extended from the main region and a tilt sensor capable of sensing a posture of the device, comprising the steps of:
displaying information on an event (hereinafter, event information), which is generated in the middle of executing an application for displaying a screen on the main region, on the sub-region;
monitoring the posture of the device via the tilt sensor; and
controlling the scroll speed of the event information displayed on the sub-region in a manner of associating the scroll speed with the posture of the device.
